(19) United States
(12) Patent Application Publication
(10) Pub. No.: US 2005/0193389 A1
(43) Pub. Date: Sep. 1, 2005

(54) System and method for a user-configurable, removable media-based, multi-package installer

(76) Inventors: Robert J. Murphy, Belmont, CA (US); John Hanay, Palo Alto, CA (US)

Correspondence Address: Robert J. Murphy, 1152 Village Drive, Belmont, CA, 94002, US

(21) Appl. No.: 11/067,079

(22) Filed: Feb. 25, 2005

Related U.S. Application Data
(60) Provisional application No. 60/548,009, filed on Feb. 26, 2004.

(51) Int. Cl. G06F 9/445

(52) U.S. Cl. 717/175; 717/169

(57) ABSTRACT

The disclosed system and method provide an administrative software application allowing a user to organize files into groups, create file packages from one or more file groups, place the file packages onto removable media, and use the installer software application residing on the removable media to select and install file packages onto handheld devices in the absence of a desktop or laptop computer. A method of installing file packages stored on a removable media onto a hand held device includes the steps of (a) automatically launching an installation application on the hand held device from a removable media, and (b) automatically installing at least one pre-selected file package onto the hand held device using the installation application.

### CROSS REFERENCE TO RELATED APPLICATIONS

The present application claims priority under 35 U.S.C. 119(e) from provisional patent application Ser. No. 60/548,009, entitled “User-Configurable, Removable Media-Based, Multi-Package Installer”, filed on Feb. 26, 2004, the disclosure of which is herein incorporated by reference in its entirety.

### BACKGROUND OF THE INVENTION

The present invention relates generally to installers and more particularly to a user-configurable, removable media-based, multi-package installer for providing an administrative application allowing a user to organize files into file groups, create file packages from file groups, place the file packages onto removable media, and use an installer application residing on the removable media to select and install file packages onto handheld devices in the absence of a desktop or laptop computer.

The use of installers for installing applications and files onto handheld devices is well known in the art. Typically, installers for handheld devices include data synchronization products such as HotSync Manager, available from PalmSource, Inc. of Sunnyvale, Calif., and ActiveSync, available from Microsoft Corporation of Redmond, Wash. These products are used to install applications onto handheld devices from a desktop or laptop computer using a docking cradle or connector. Other conventional products allow for the download of applications and files over a network connection, either wired or wireless, or transmission of data using point-to-point technologies, such as Infrared.

Prior art data synchronization products suffer the disadvantage of being designed with the intent that the handheld device is connected to a desktop or laptop computer with the data synchronization application running on the computer and data being transferred as part of a data synchronization operation. These products do not provide a means of installing applications and files onto handheld devices in the absence of a desktop or laptop computer.

Conventional products which provide for the copying of files from a flash memory card or from transmissions using Infrared suffer the disadvantage that the files are selected and copied individually, thereby taking considerable time and effort to copy several files. In addition, while the handheld device's operating system provides a method for copying files, it is generally inefficient to use since it only allows the user to copy files one at a time. Another problem with conventional methods is they were designed to install applications and data onto a single handheld device and do not provide any efficiencies for installing the same files, or different files, repeatedly onto a large number of handheld devices. Techniques employed for one handheld device are generally not suited for installing files onto large numbers of handheld devices.

There is therefore a need in the art for a system and method for a user-configurable, removable media-based, multi-package installer which overcomes the disadvantages of the prior art. Preferably the system and method provide a means of installing applications and files onto handheld devices in the absence of a desktop or laptop computer. The system and method also preferably provides a means of installing files onto large numbers of handheld devices.

### SUMMARY OF THE INVENTION

In accordance with one aspect of the invention, a method of installing files on a hand held device includes the steps of (a) automatically launching an installation application on the hand held device from a removable media, (b) selecting at least one file package stored on the removable media for installation, and (c) installing the selected at least one file package on the hand held device using the installation application.

In accordance with another aspect of the invention, a method of installing file packages stored on a removable media onto a hand held device includes the steps of (a) automatically launching an installation application on the hand held device from a removable media, and (b) automatically installing at least one pre-selected file package onto the hand held device using the installation application.

In accordance with yet another aspect of the invention, a user configurable method of installing files on a hand held device using a removable media includes the steps of (a) creating at least one file package, (b) storing the at least one file package on the removable media, (c) automatically launching an installation application stored on the removable media on the hand held device, and (d) installing the at least one file package on the hand held device using the installer application.

In accordance with another aspect of the invention, a system for installing files on a hand held device includes a processor operable to automatically launch an installation application on the hand held device from a removable media, allow user selection of at least one file package stored on the removable media for installation on the hand held device, and install the selected at least one file package on the hand held device.

In accordance with yet another aspect of the invention, a system for installing files on a hand held device includes a processor operable to automatically launch an installation application on the hand held device from a removable media, and automatically install at least one pre-selected file package onto the hand held device using the installation application.

In accordance with another aspect of the invention, a user configurable system for installing files on a hand held device using a removable media includes a first processor operable to allow user creation of at least one file package and storage of the at least one file package on the removable media, and a second processor operable to automatically launch an installation application stored on the removable media on the hand held device, and install the at least one file package on the hand held device using the installer application.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

FIG. 1 is a schematic representation of a representative hardware environment in which the present invention may be practiced;

FIG. 2 is a flow diagram illustrating an administrative software application in accordance with the present invention;

FIG. 3 is a flow diagram illustrating an install software application in accordance with the present invention;

FIG. 4 is a screen shot of a user screen for creating file groups in accordance with the present invention;

FIG. 5 is a screen shot of a user screen for naming a file group in accordance with the present invention;

FIG. 6 is a screen shot of a user screen for adding a task to a Memo Pad in accordance with the present invention;

FIG. 7 is a screen shot of a user screen for adding a task to a Date Book in accordance with the present invention;

FIG. 8 is a screen shot of a user screen for adding a task to a To Do List in accordance with the present invention;

FIG. 9 is a screen shot of a user screen for creating a file package in accordance with the present invention;

FIG. 10 is a screen shot of a user screen for selecting a file package in accordance with the present invention;

FIG. 11 is a screen shot of an insufficient free space error message in accordance with the present invention;

FIG. 12 is a screen shot of an install failure error message in accordance with the present invention;

FIG. 13 is a screen shot of a user screen for viewing file package information in accordance with the present invention

FIG. 14 is a screen shot of a user screen for deleting a file package in accordance with the present invention;

FIG. 15 is a screen shot of a user screen for enabling auto install in accordance with the present invention;

FIG. 16 is a screen shot of a user screen for selecting file packages to be automatically installed in accordance with the present invention; and

FIG. 17 is a screen shot of an auto install circumvent message in accordance with the present invention.

### DETAILED DESCRIPTION OF THE INVENTION

The present invention relates to a system and method for providing an administrative software application allowing a user to organize files into groups, create file packages from one or more file groups, place the file packages onto removable media, and use an installer software application residing on the removable media to select and install file packages onto handheld devices in the absence of a desktop or laptop computer.

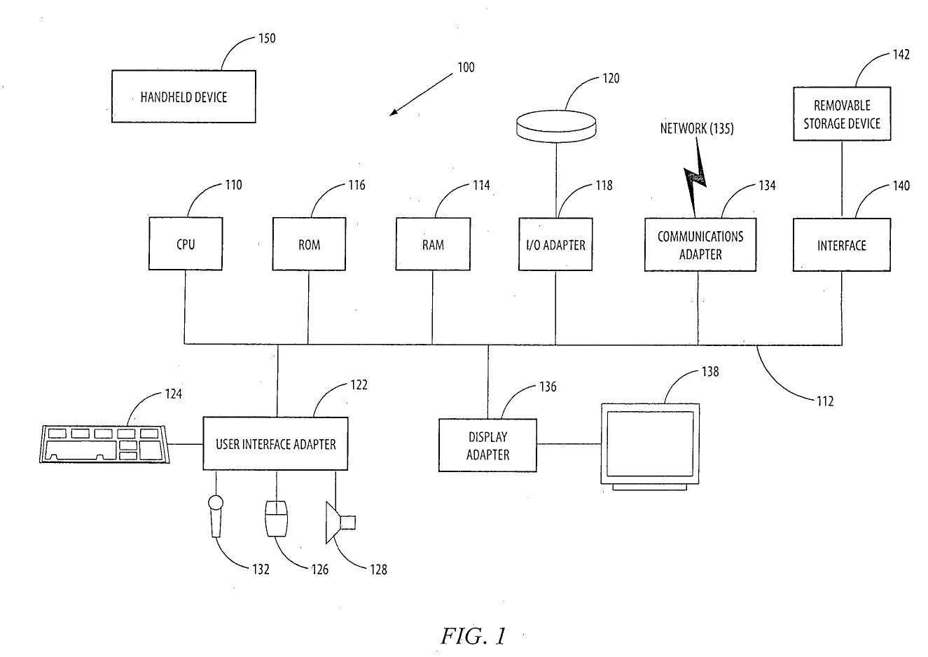

The present invention may be implemented using hardware, software, or a combination thereof and may be implemented in a computer system generally designated 100 or other processing system as shown in FIG. 1. In one aspect of the invention, the invention is directed toward the computer system 100 capable of carrying out the functionality described herein. The computer system 100 may include one or more processors 110. The processor 110 may be connected to a communication bus 112. Various software embodiments are described in terms of this exemplary computer system 100. After reading this description, it will become apparent to one skilled in the art how to implement the invention using other computer systems and/or computer architectures.

Computer system 100 may also include a main memory, preferably random access memory (RAM) 114, a read only memory (ROM) 116, and a secondary memory including a secondary memory drive 118 and a secondary memory device such as a magnetic or optical disk 120. Computer system 100 may also include an interface 140 such as a USB interface, a PCI Express interface, and an ExpressCard interface. The interface 140 may provide an interface to a removable storage device 142 such as a flash memory card. As will be appreciated, the removable storage device 142 may include a computer usable storage medium having stored therein computer software and/or data. Interface 140 may further allow software and data to be transferred from the removable storage device 142 to the computer system 100 and to a handheld device 150.

Computer system 100 may also include a communications adapter 134 for communication with a network 135 and remote devices such as the handheld device 150. Communications adapter 134 allows software and data to be transferred between the computer system 100 and external devices including storage devices and the handheld device 150. Examples of communications adapter 134 may include a modem, a network interface (such as an Ethernet card), a communications port, and a PCMCIA slot and card. Software and data transferred via communications adapter 134 are in the form of signals which can be electronic, electromagnetic, optical or other signals capable of being received by communications adapter 134. These signals are provided to the communications adapter 134 via a channel. The channel may carry signals and may be implemented using wire, cable, fiber optic cable, phone lines, cellular phone link, an RF link and other communications channels.

In this description, the terms “computer program medium” and “computer usable medium” are used to generally refer to media such as removable storage devices 142, the secondary memory device 120 including a hard disk installed in the secondary memory drive 118, and signals. These computer program products are means for providing software to the computer system 100 and the handheld device 150.

Computer programs (also called computer control logic) may be stored in main memory 114, secondary memory 120, and in the removable storage device 142. Computer programs may also be received via communications adapter 134. Such computer programs, when executed, enable the computer system 100 and the handheld device 150 to perform the features of the present invention as discussed herein. In particular, the computer programs, when executed enable the processor 110 and a handheld device processor (not shown) to perform the features of the present invention. Accordingly, such computer programs represent controllers of the computer system 100 and the handheld device 150.

In an embodiment where the invention is implemented using software, the software may be stored in a computer program product and loaded into the computer system 100 and handheld device 150 using the removable storage device 142 and/or communications adapter 134. The control logic (software), when executed by the processor 110 and handheld device processor, causes the processor 110 and handheld device processor to perform the functions of the invention as described herein. In one aspect of the invention, the administrative software application may be stored in the RAM 114 or in the secondary memory 120 and the installer software application may be stored in the removable storage device 142.

In another aspect of the invention, the invention may be implemented primarily in hardware using, for example, hardware components such as application specific integrated circuits (ASICS). Implementation of the hardware state machine so as to perform the functions described herein will be apparent to persons skilled in the relevant art. In yet another embodiment, the invention may be implemented using a combination of both hardware and software.

In one aspect of the invention, the administrative software application provides a means for creating, editing, and deleting file groups, and creating file packages from one or more file groups. A file group may include one or more files, data such as Date Book, To Do List and Memo Pad entries, and a title, all of which are saved to data repositories connected to the computer system 100 which may include a desktop and laptop computer. When file groups are processed for use by the installer software application, the administrative software application may create a file package, which can be saved to the removable storage device 142 and to storage devices connected to the computer system 100.

The installer software application may be stored on the removable storage device 142 including a flash memory card of the type used by handheld devices 150 to store information. The installer software application may launch when the removable storage device 142 is inserted into the handheld device 150, allowing the user to select a file package from a list of available file packages and install the selected file package onto the handheld device 150. The installer software application may be configured to automatically install a pre-selected file package when the removable storage device 142 is inserted into the handheld device 150. The installer software application may include an option to remove unwanted file packages from the removable storage device 142.

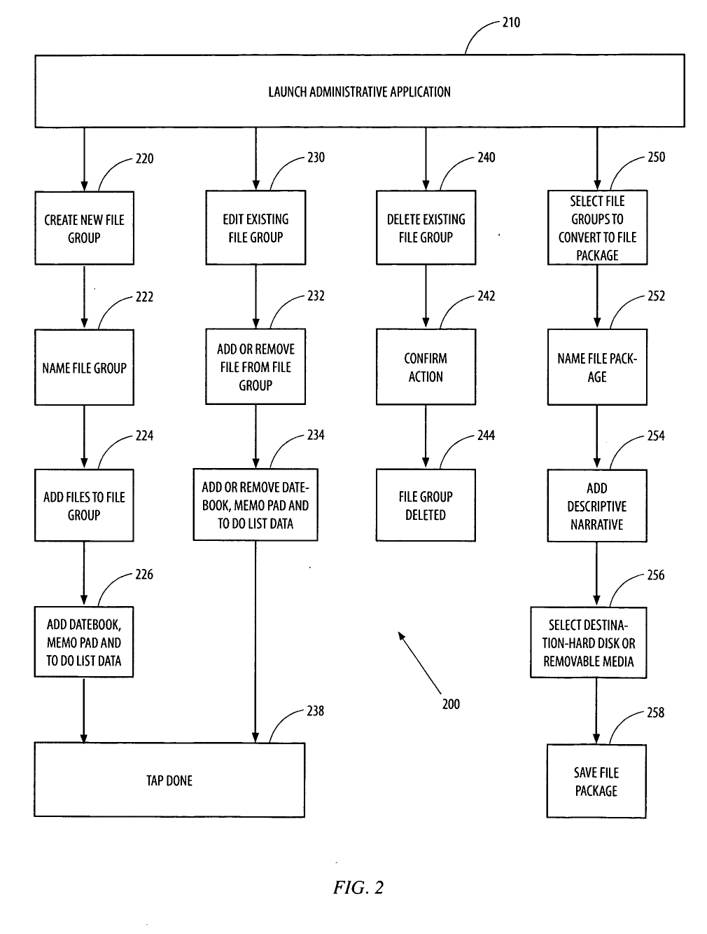

The administrative software application may include a process generally designated 200 that manages file groups and creates file packages for use by the installer software application as shown in FIG. 2. Process 200 may include a step 210 in which the administrative software application may be launched by the computer system 100. A new file group may be created in a step 220, an existing file group may be edited in a step 230, an existing file group may be deleted in a step 240, and file groups may be selected for conversion to a file package in a step 250.

To create a new file group following step 220, in a step 222 a name of the new file group may be selected. In a step 224 files may be added to the new file group. Date Book, Memo Pad and To Do List data may be added to the new file group in a step 226. Finally, in a step 238, the new file group may be saved to RAM 114, disk 120 and/or other storage devices by tapping “Done” on a user interface screen (not shown).

An existing file group may be edited following step 230 in a step 232 in which files may be added or removed from the existing file group. In a step 234 Date Book, Memo Pad and To Do List data may be added or removed from the existing file group. In a step 238, the files added or removed and Date Book, Memo Pad and To Do List data added or removed may be saved to RAM 114, disk 120 and/or other storage devices by tapping “Done” on a user interface screen (not shown).

To delete an existing file group after the step 240, a user prompt may be given to the user in a step 242. In a step 244 the existing file group may be deleted.

To convert a file group or file groups to the file package following step 250, the file package may be named in a step 252. In a step 254 a descriptive narrative may be added to the file package. A destination such as hard disk 120 or removable storage device 142 may be selected in a step 256. Finally in a step 258 the file package may be saved to the selected destination. The saved file package may be used by the installer software application as further described herein. Preferably, the saved file package includes a data structure optimized for the type of intended handheld device 150 and delivery method.

In other aspects of the invention, the administrative software application may include a process which is part of a larger content or file management system where the file packages are created as needed and distributed by messaging and content systems in addition to local storage devices. Preferably the file packages include a facility for allowing the user to access individual files and file groups contained in the file package using the administrative software application or the installer software application as well as allowing the file package to be deconstructed into its original elements.

Removable storage device 142 includes any type of portable media upon which the installer software application resides, such as a flash memory card used by handheld devices 150 to store information. Removable storage device 142 refers to any read/write or read-only media, whether mechanical or electronic, used to store electronic data for use by the computer system 100 and handheld device 150. Removable storage device 142 may be the primary method for transporting and installing file packages. Other possible embodiments for transporting and installing file packages include traditional network technologies, including wired and wireless networks, and point-to-point transport technologies, such as Infrared.

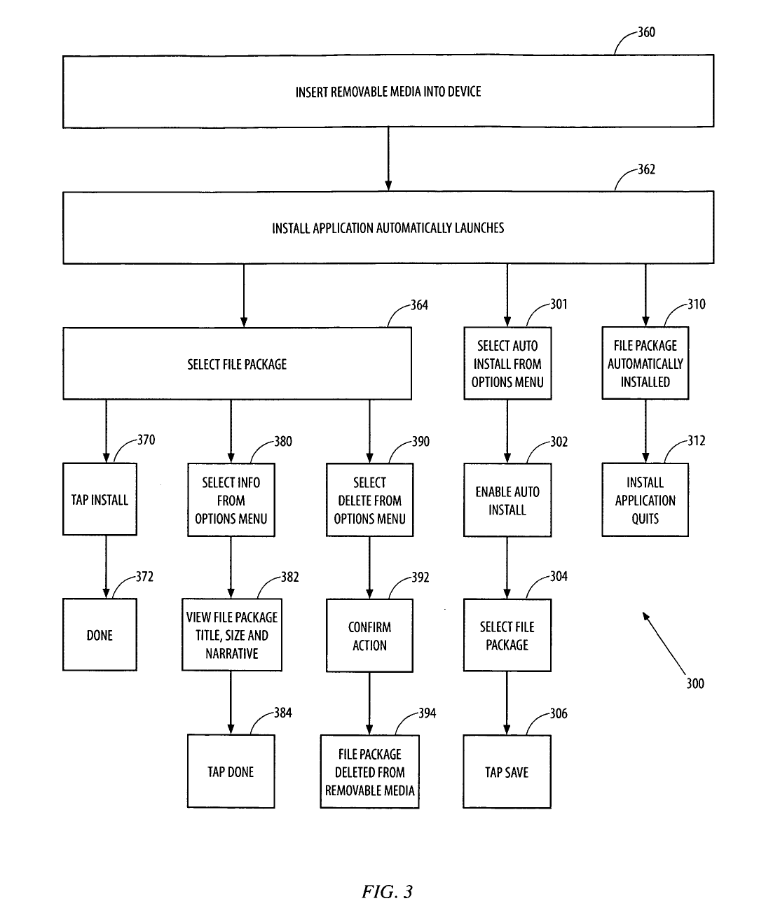

The installer software application may include a process generally designated 300 as shown in FIG. 3 that may be executed by a handheld device processor (not shown). In a step 360 the removable storage device 142 having stored thereon the installer software application may be inserted into the handheld device 150. The handheld device processor may automatically launch the installer software application in a step 362. In a step 364 the user may select a file package for installation onto the handheld device 150. Once selected, the file package may be installed onto the handheld device 150 in a step 370 and the method completed in a step 372 by tapping “Done” on a user interface.

In a step 380, the user may select information about a file package from an options menu. Information including a title, size and the file package narrative may be viewed in a step 382. In a step 384 the method may be completed by tapping “Done” on a user interface.

The user may delete a file package from the removable storage device 142 in a step 390. In a step 392, the user may be prompted to confirm the deletion of the file package. Finally in a step 394, the file package may be deleted from the removable storage device 142.

A file package may be selected from auto installation when the removable storage device 142 is inserted into subsequent handheld devices 150. In a step 301, the user may select auto-install from the options menu. The auto-install may be enabled in a step 302. In a step 304 a file package may be selected for auto installation. The auto installation feature may be saved in a step 306.

In another aspect of the invention, file packages may be automatically installed in a step 310 if auto installation has been selected. Process 300 may quit in a step 312.

Other possible embodiments of the installer software application include the ability to concurrently install several file packages by allowing the user to select one or more file packages in the list, file packages residing on the handheld device 150 could automatically be transferred from the handheld device 150 to the removable storage device 142 by the installer software application, the installer software application could be restricted to install a single file package, without any provisions for installing other file packages, and the installer software application could allow the user to select files residing on the handheld device 150 and create a file package without the use of the administrative software application.

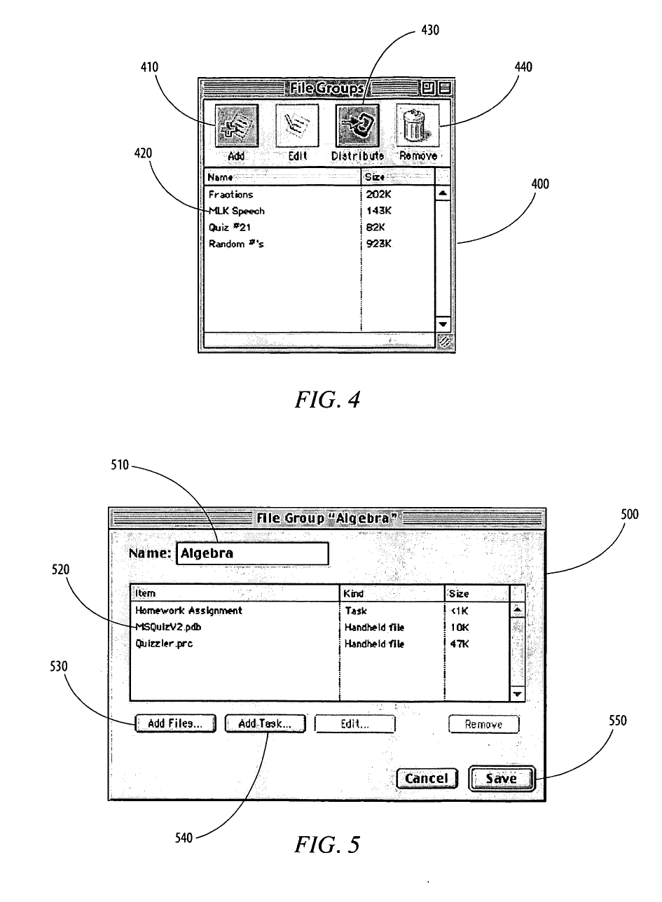

Upon the launch of the administrative software application by process 200, a screen 400 may be displayed to a user on display 138 (FIG. 1) as shown in FIG. 4. To create a new file group 420, the user may click the Add button 410 in step 220. A screen 500 may then be displayed as shown in FIG. 5 and a new file group 510 may be named in step 222. Files 520 may be added to the new file group 510 in step 224 by clicking a Add Files button 530. Step 224 may be completed by clicking a Save button 550.

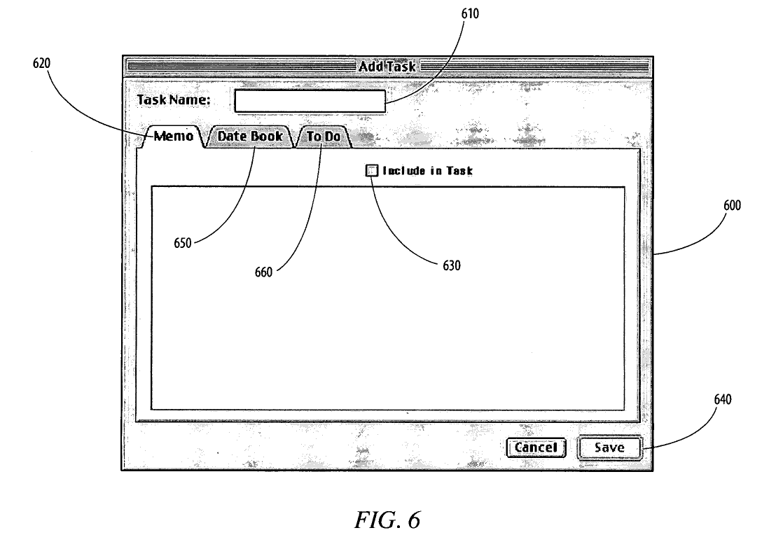

To add a task to the Memo Pad in step 226, a file group 420 (FIG. 4) may be double clicked. Screen 500 (FIG. 5) may be displayed to the user. By clicking a Add Task button 540, a screen 600 may be displayed as shown in FIG. 6. A task may be named in box 610 and a memo 620 created and included by checking an Include in Task box 630. Step 226 may be completed by clicking a Save button 640.

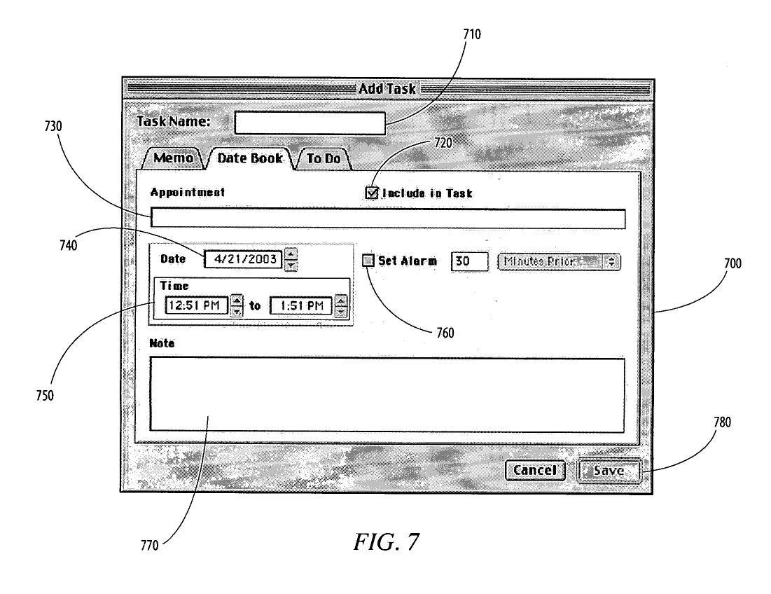

To add a task to the Date Book in step 226, a Date Book button 650 may be clicked to display a screen 700 as shown in FIG. 7. A task may be named in box 710 and included by checking an Include in Task box 720. A name may be given to an appointment in an Appointment box 730, a due date set in a Date box 740, a time set in a Time boxes 750, an alarm set in a Set Alarm box 760, and a note created in a Note box 770. Step 226 may be completed by clicking a Save button 780.

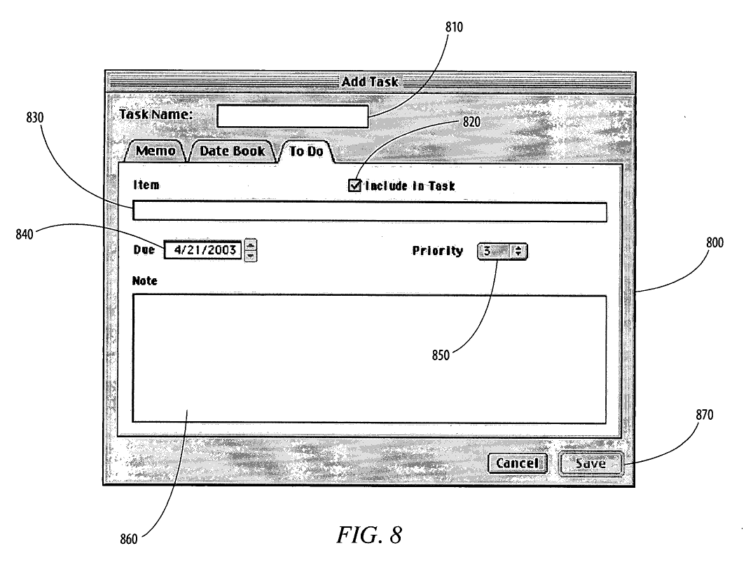

To add a task to the To Do List in step 226, a To Do button 660 (FIG. 6) may be clicked to display a screen 800 as shown in FIG. 8. A task may be named in box 810 and included by checking an Include in Task box 820. A name may be given to the To Do item in a box 830, a due date may be set in a Due box 840, a priority may be set in a Priority box 850 and a note may be created in a Note box 860. Step 226 may be completed by clicking a Save button 870.

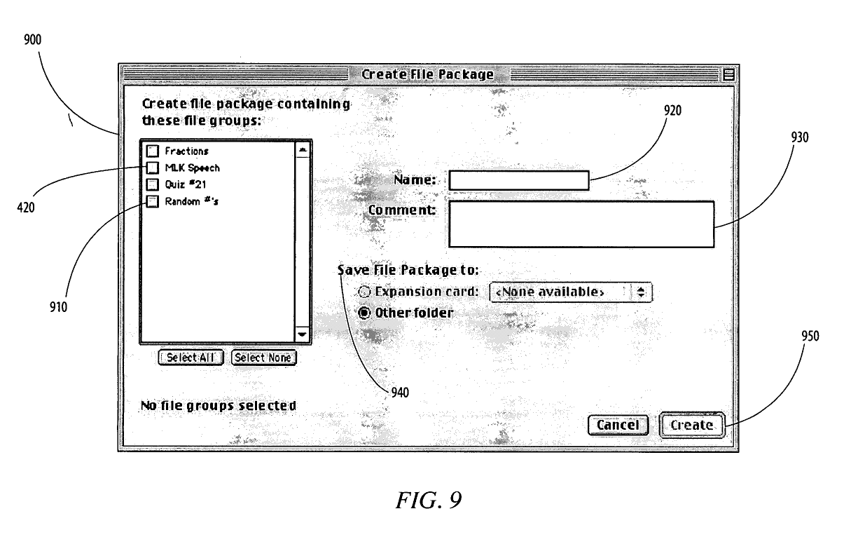

To convert a file group 420 into the file package in step 250, from the screen 400, the user may select a Distribute button 430. A screen 900 may be displayed as shown in FIG. 9. File groups 420 may be selected for inclusion in the file package by selecting selection boxes 910. A name may be given to the file package in a Name box 920 in step 252. Step 254 may include adding a descriptive narrative in a Comment box 930. Step 256 may include selecting a destination by selecting a Save File Package to: button 940. The file package may be created by selecting a Create button 950.

Those skilled in the art will appreciate that similar screens may be utilized to implement the editing and deleting of file groups 420 of process 200. As such no further discussion as to the implementation details will be provided.

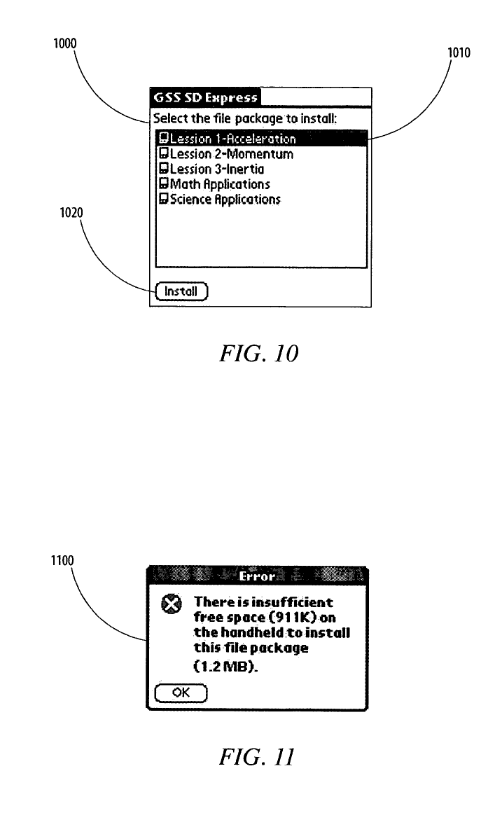

To install a file package onto the handheld device 150 using the installer software application, the removable storage device 142 may be inserted into the handheld device in step 360. The installer software application may launch in step 362 and a user interface 1000 be displayed as shown in FIG. 10. If the installer software application does not launch automatically, an icon (not shown) may be tapped to manually launch the installer software application.

The file package 1010 to be installed may be selected in step 364 and an Install button 1020 tapped in step 370 to install the file package 1010.

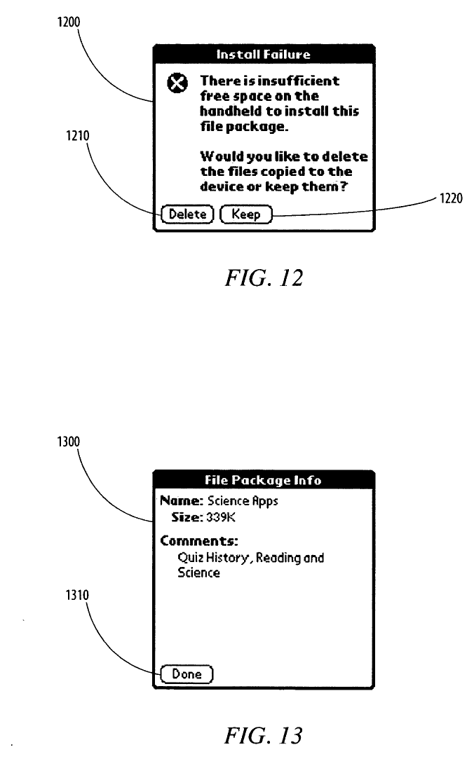

In the case where there is insufficient space on the handheld device 150 to install the file package 1010, an error message 1100 shown in FIG. 11 may be displayed. To install the file package 1010 onto the handheld device 150, files may be deleted from the handheld device 150. Due to differences in file formats, it may be possible that some files 520 (FIG. 5) will be installed before the installer software application ascertains that there is insufficient space to continue installation of the file package 1010. In this case, an error message 1200 shown in FIG. 12 may be displayed. The user may tap either a Delete button 1210 or a Keep button 1220 to delete to keep the installed files 520. If an updated version of an application was installed on the handheld device 150 before the error message 1200 is displayed, the updated application will not be deleted by tapping the Delete button 1210.

To view narrative information for the file package 1010, a menu icon (not shown) may be tapped. From an Options menu (not shown), an Info option (not shown) may be selected in the step 380. Upon selecting the Info option, a screen 1300 may be displayed as shown in FIG. 13 and the user may view the information in the step 382. To return to the main screen of the handheld device 150, the user may tap a Done button 1310 in the step 384.

File packages 1010 may be stored in RAM 114 and on the removable storage device 142. Before deleting file packages 1010, care should be taken to ensure that the file groups 420 are stored in either RAM 114 or on the removable storage device 142 if the file groups 420 will be accessed in the future. Generally file groups 420 may be stored in RAM 114 as the file groups 420 are created using the administrative software application running on the computer system 100.

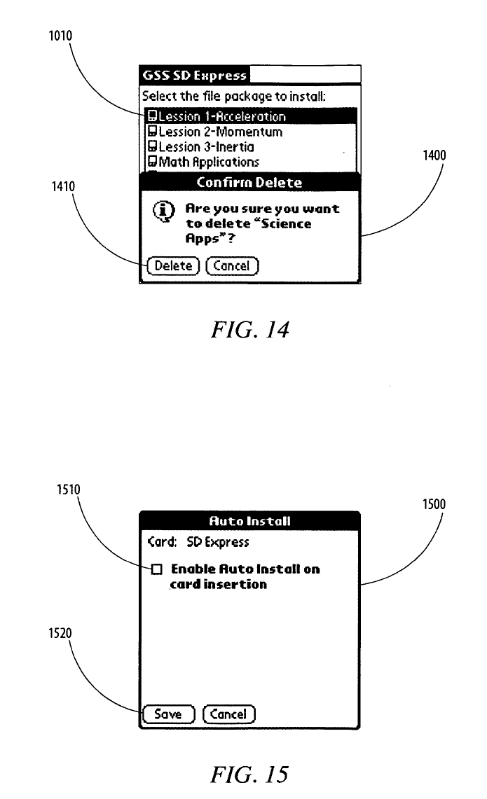

A file group 420 may be deleted from RAM 114 or other storage media coupled to the computer system 100 by launching the administrative software application. Screen 400 (FIG. 4) may be displayed to the user from which the user may select the file group 420 to delete, and delete the selected file group 420 by selecting a Remove button 440. To delete a file package 1010, the file package 1010 may be selected from the screen 1000 (FIG. 10). The Delete button (not shown) may then be selected from the Options menu (not shown) in the step 390. A screen 1400 shown in FIG. 14 may be displayed and the user given an option of confirming the deletion in the step 392. To delete the selected file package 1010, a Delete button 1420 may be selected in the step 394.

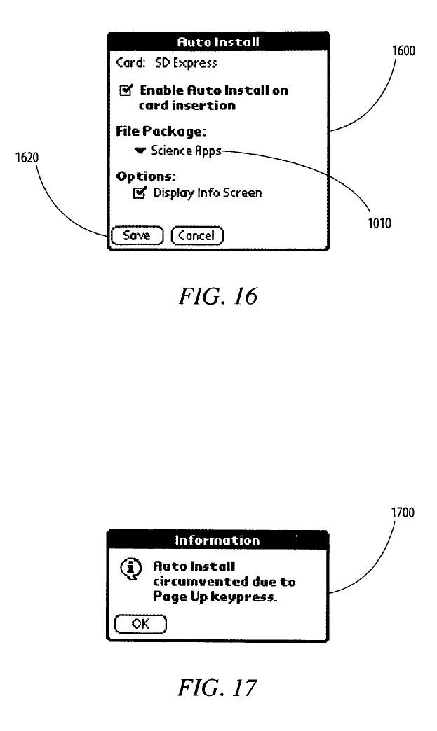

The installer software application may be configured to speed the installation of file packages 1010 such that pre-selected file packages 1010 are installed automatically upon insertion of the removable storage device 142 into the handheld device 150. Upon launching of the installer software application in the step 362, an Auto-Install button (not shown) may be selected from the Options menu (not shown). A screen 1500 may be displayed as shown in FIG. 15. In the step 302 an Enable Auto Install on card insertion button 1510 may be selected. File packages 1010 to be automatically installed may be selected in the step 304 by selecting the file package 1010 to be installed in a screen 1600 shown in FIG. 16. A save button 1620 may be selected in the step 306 to save the file packages 1010 selected for automatic installation. The next time the removable storage device 142 is inserted in the handheld device 150, the selected file packages 1010 will be automatically installed on the handheld device 150 in the step 310. The install software application will then quit in the step 312.

The Auto Install process may be circumvented by pressing a Page UP key (not shown) on the handheld device 150. A screen 1700 may be displayed as shown in FIG. 17.

The present invention overcomes the disadvantages of the prior art by providing a system and method for providing an administrative software application allowing a user to organize files into groups, create file packages from one or more file groups, place the file packages onto removable media, and use an installer software application residing on the removable media to select and install file packages onto handheld devices in the absence of a desktop or laptop computer.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method of installing files on a hand held device comprising the steps of:
(a) automatically launching an installation application on the hand held device from a removable media;
(b) selecting at least one file package stored on the removable media for installation; and
(c) installing the selected at least one file package on the hand held device using the installation application.

2. The method of claim 1, wherein the at least one file package comprises at least one group of files.

3. The method of claim 2, wherein the at least one group of files comprises at least one file.

4. The method of claim 2, wherein the at least one group of files comprises data.

5. The method of claim 4, wherein the data comprises date book data.

6. The method of claim 4, wherein the data comprises to do list data.

7. The method of claim 4, wherein the data comprises memo pad data.

8. The method of claim 4, wherein the data comprises a title.

9. The method of claim 1, further comprising viewing information related to the selected at least one file package.

10. The method of claim 1, further comprising deleting the selected at least one file package.

11. The method of claim 1, further comprising selecting at least one file package for automatic installation.

12. A method of installing file packages stored on a removable media onto a hand held device comprising the steps of:
(a) automatically launching an installation application on the hand held device from a removable media; and
(b) automatically installing at least one pre-selected file package onto the hand held device using the installation application.

13. The method of claim 12, wherein the pre-selected file package comprises at least one group of files.

14. A user configurable method of installing files on a hand held device using a removable media comprising the steps of:
(a) creating at least one file package;
(b) storing the at least one file package on the removable media;
(c) automatically launching an installation application stored on the removable media on the hand held device; and
(d) installing the at least one file package on the hand held device using the installer application.

15. The method of claim 14, wherein step (d) is executed automatically.

16. The method of claim 14, further comprising selecting file packages from the at least one file package for installation on the hand held device.

17. The method of claim 14, further comprising selecting file packages from the at least one file package for automatic installation on the hand held device.

18. A system for installing files on a hand held device comprising:
a processor operable to automatically launch an installation application on the hand held device from a removable media, allow user selection of at least one file package stored on the removable media for installation on the hand held device, and install the selected at least one file package on the hand held device.

19. A system for installing files on a hand held device comprising:
a processor operable to automatically launch an installation application on the hand held device from a removable media, and automatically install at least one pre-selected file package onto the hand held device using the installation application.

20. A user configurable system for installing files on a hand held device using a removable media comprising:
a first processor operable to allow user creation of at least one file package and storage of the at least one file package on the removable media; and
a second processor operable to automatically launch an installation application stored on the removable media on the hand held device, and install the at least one file package on the hand held device using the installer application.
